(19) United States
(12) Patent Application Publication
(10) Pub. No.: US 2026/0208600 A1
(43) Pub. Date: Jul. 23, 2026

(54) TORQUE CONTROL SYSTEM FOR AN ELECTRIC VEHICLE

(71) Applicant: FOXTRON VEHICLE TECHNOLOGIES CO., LTD., New Taipei City (TW)

(72) Inventors: CHIEN-CHIH YIN, New Taipei City (TW); CHIN-TE LAI, New Taipei City (TW); DA-WEN XU, New Taipei City (TW); WEI-HSIU LIN, New Taipei City (TW)

(21) Appl. No.: 19/183,945

(22) Filed: Apr. 21, 2025

(30) Foreign Application Priority Data
Jan. 23, 2025 (TW) 114200953

(51) Int. Cl. B60L 15/20

(52) U.S. Cl. CPC B60L 15/2009; B60L 2240/12; B60L 2240/14; B60L 2240/423; B60L 2250/28

(57) ABSTRACT

A torque control system for an electric vehicle includes an accelerator pedal, a brake pedal, a motor assembly, and a control module. The motor assembly is electrically connected to the accelerator pedal and the brake pedal, and outputs a forward torque. The control module is configured to obtain a vehicle speed of the electric vehicle and a pedal position of the accelerator pedal, and determines a target acceleration of the electric vehicle accordingly. The control module calculates the target acceleration and a longitudinal acceleration of the electric vehicle to obtain an acceleration difference, and the control module determines a torque variation based on the acceleration difference and the vehicle speed. Then, the control module performs a torque superposition calculation on the forward torque based on the torque variation, and controls the motor assembly to adjust the forward torque accordingly.

### CROSS-REFERENCE TO RELATED PATENT APPLICATION

This application claims the benefit of priority to Taiwan Patent Application No. 114200953, filed on January 23, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a torque control system, and more particularly to a torque control system for an electric vehicle.

### BACKGROUND OF THE DISCLOSURE

The operation of an electric vehicle (EV) or hybrid vehicle is driven by torque output from its internal drive system. Generally, the torque output control in an electric vehicle is paired with settings such as driving modes and regenerative braking levels (also known as regen level). The final torque output is calibrated and determined by using lookup tables designed based on different combinations of these settings. Since different driving modes and regenerative braking levels correspond to distinct lookup tables, the sheer number of tables becomes excessive. This not only increases the memory demand on the electric vehicle’s internal controller, but also extends the time required for calibration.

Furthermore, current electric vehicles control the motor to output torque based on the torque commands issued by a driver, thereby adjusting the electric vehicle’s acceleration. In other words, when driving on roads with varying inclines, the driver needs to frequently press down on the accelerator pedal according to road conditions to adjust the output torque and control the vehicle speed of the electric vehicle, increasing the complexity of vehicle handling for the driver.

Therefore, how to overcome the above-mentioned problem through an improvement in control and structural design of the electric vehicle has become an important issue to be addressed in the related art.

### SUMMARY OF THE DISCLOSURE

In response to the above-referenced technical inadequacies, the present disclosure provides a torque control system for an electric vehicle, so as to address the issue of the electric vehicle’s internal control system requiring excessive effort for torque calibration, and the driver frequently needing to adjust the accelerator opening.

In order to solve the above-mentioned problems, one of the technical aspects adopted by the present disclosure is to provide a torque control system for an electric vehicle including an accelerator pedal, a brake pedal, a motor assembly, and a control module. The motor assembly is electrically connected to the accelerator pedal and the brake pedal and outputs a forward torque. The control module is electrically connected to the motor assembly, the accelerator pedal, and the brake pedal. The control module is configured to obtain a vehicle speed of the electric vehicle and a pedal position of the accelerator pedal, and determine a target acceleration of the electric vehicle accordingly. The control module calculates the target acceleration and a longitudinal acceleration of the electric vehicle to obtain an acceleration difference, and the control module determines a torque variation based on the acceleration difference and the vehicle speed. Then, the control module performs a torque superposition calculation on the forward torque based on the torque variation, and controls the motor assembly to adjust the forward torque accordingly.

Therefore, the torque control system for the electric vehicle provided by the present disclosure outputs acceleration-based control commands to control the output torque of the electric vehicle. The driver only needs to determine different target accelerations, and the torque control system can calculate an appropriate torque for the vehicle at that moment. As a result, the number of lookup tables stored in the system can be reduced and the calibration time can be shortened. Furthermore, since the output torque of the electric vehicle is adjusted based on the vehicle’s overall acceleration, the effects of road surface variations, road inclines, and vehicle load during operation can be mitigated, eliminating the need for the driver to frequently press down on the accelerator pedal according to road conditions, thereby reducing the complexity of vehicle handling.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a torque control system for an electric vehicle according to the present disclosure;

FIG. 2 is a functional block diagram of a control module of the torque control system for the electric vehicle according to the present disclosure;

FIG. 3 is a schematic view of a driver driving the electric vehicle;

FIG. 4 is a schematic view of step S1 to S4 of the torque control system for the electric vehicle according to the present disclosure;

FIG. 5 is a schematic view of step S11 and S12 of the torque control system for the electric vehicle according to the present disclosure;

FIG. 6 is a schematic view of an acceleration mapping table of the torque control system for the electric vehicle according to the present disclosure;

FIG. 7 is a schematic view of step S31 and S32 of the torque control system for the electric vehicle according to the present disclosure;

FIG. 8 is a schematic view of step S41 and S42 of the torque control system for the electric vehicle according to the present disclosure; and

FIG. 9 is a schematic view of step S101 and S109 of the torque control system for the electric vehicle according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

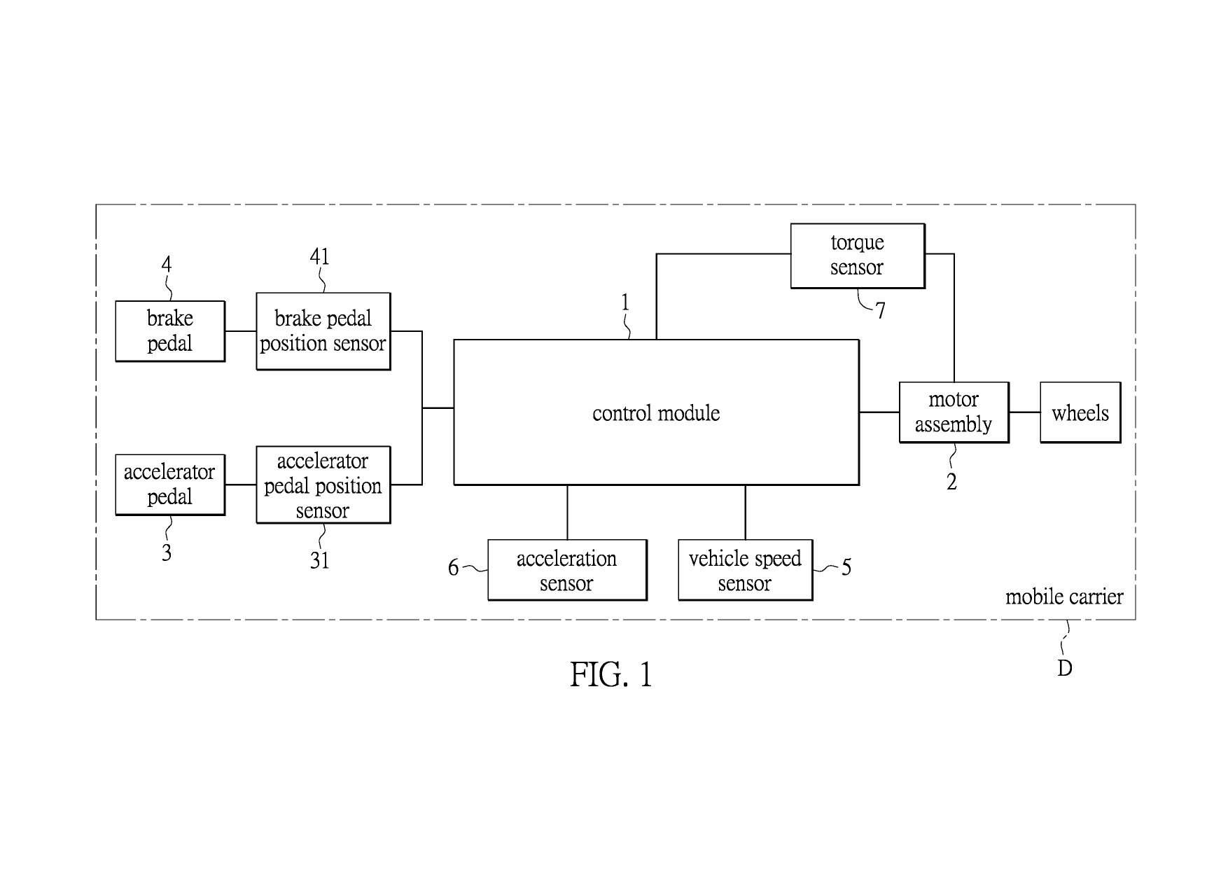

Referring to FIG. 1, the present disclosure provides a torque control system for a mobile carrier D. In a preferred embodiment, the mobile carrier D is exemplified using an electric vehicle. However, the specific implementation of the mobile carrier D is not limited in the present disclosure. For example, the mobile carrier D can also be a hybrid vehicle.

The electric vehicle of the present disclosure includes a control module 1, a motor assembly 2, an accelerator pedal 3, and a brake pedal 4. For example, the motor assembly 2 can be an electric motor. When a driver presses down on the accelerator pedal 3, the motor assembly 2 outputs a forward torque to drive the electric vehicle to accelerate. In addition, the accelerator pedal 3 can be either an electric pedal or a combined throttle and electric pedal. If the mobile carrier D is an electric vehicle, the accelerator pedal 3 is an electric pedal. If the mobile carrier D is a hybrid vehicle, the accelerator pedal 3 is a combined throttle and electric pedal. The torque control system for the electric vehicle further includes a vehicle speed sensor 5, an acceleration sensor 6, and a torque sensor 7. The vehicle speed sensor 5 is used to detect the speed of the electric vehicle, while the acceleration sensor 6 is used to detect the longitudinal acceleration of the electric vehicle.

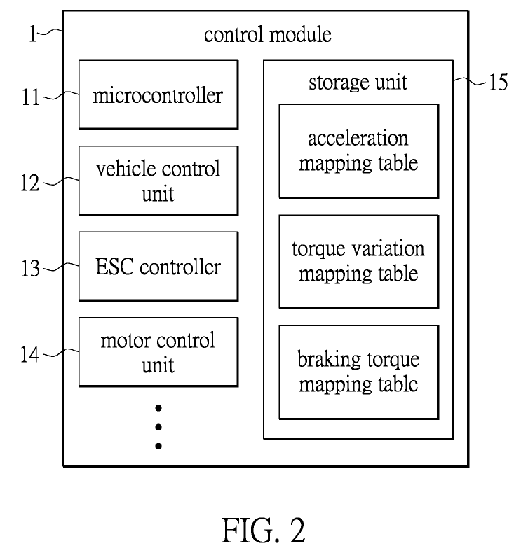

Reference is made to FIG. 2. The control module 1 includes a microcontroller 11 and a vehicle control unit (VCU) 12, but the present disclosure is not limited thereto. For example, the control module 1 can further include an ESC controller 13, a motor control unit (MCU) 14, and a storage unit 15. The storage unit 15 can include, but is not limited to, random access memory (RAM), flash memory, and solid-state drives (SSD). In the present disclosure, the control module 1 can be regarded as an assembly of all of the control components, signal processing components, and storage components within the vehicle. Moreover, the control module 1 can be used for vehicle control and for the calculation, processing, and storage of vehicle operation data or parameters. For example, the control module 1 can receive various sensor signals output by the vehicle's sensors to obtain vehicle information, and further perform reading and analysis to output corresponding control signals to relevant components, thereby instructing them to execute the corresponding actions.

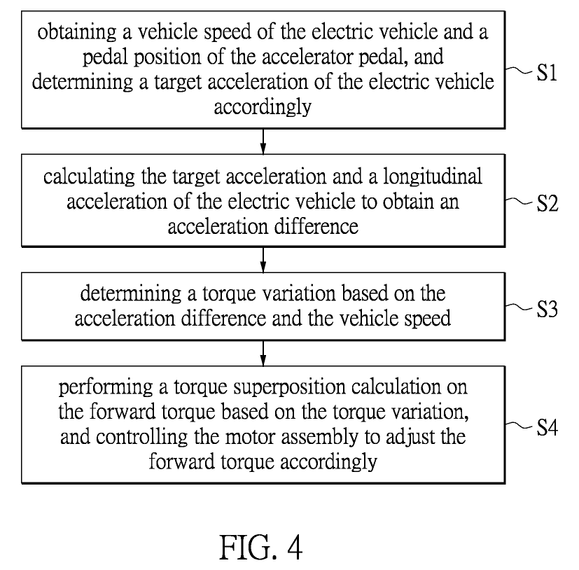

Reference is further made to FIG. 1. The following provides a detailed explanation of steps S1 to S4 of the torque control system, which can be referenced in conjunction with FIG. 4.

Step S1: obtaining a vehicle speed of the electric vehicle and a pedal position of the accelerator pedal, and determining a target acceleration of the electric vehicle accordingly.

Step S2: calculating the target acceleration and a longitudinal acceleration of the electric vehicle to obtain an acceleration difference.

Step S3: determining a torque variation based on the acceleration difference and the vehicle speed.

Step S4: performing a torque superposition calculation on the forward torque based on the torque variation, and controlling the motor assembly to adjust the forward torque accordingly.

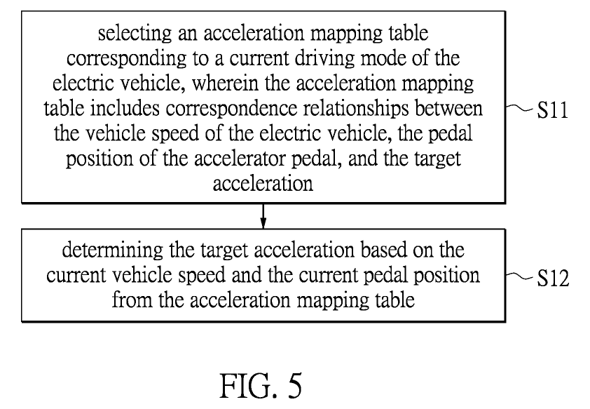

Referring to FIGS. 1, 4, and 5, in step S1, when the driver presses down on the accelerator pedal 3 to accelerate the electric vehicle, the control module 1 detects and obtains the pedal position of the accelerator pedal 3 through an accelerator pedal position sensor 31, and detects and obtains the vehicle speed of the electric vehicle through a vehicle speed sensor 5. Then, the control module selects an acceleration mapping table corresponding to a current driving mode of the electric vehicle (step S11) and determines the target acceleration based on the current vehicle speed and the current pedal position from the acceleration mapping table (step S12).

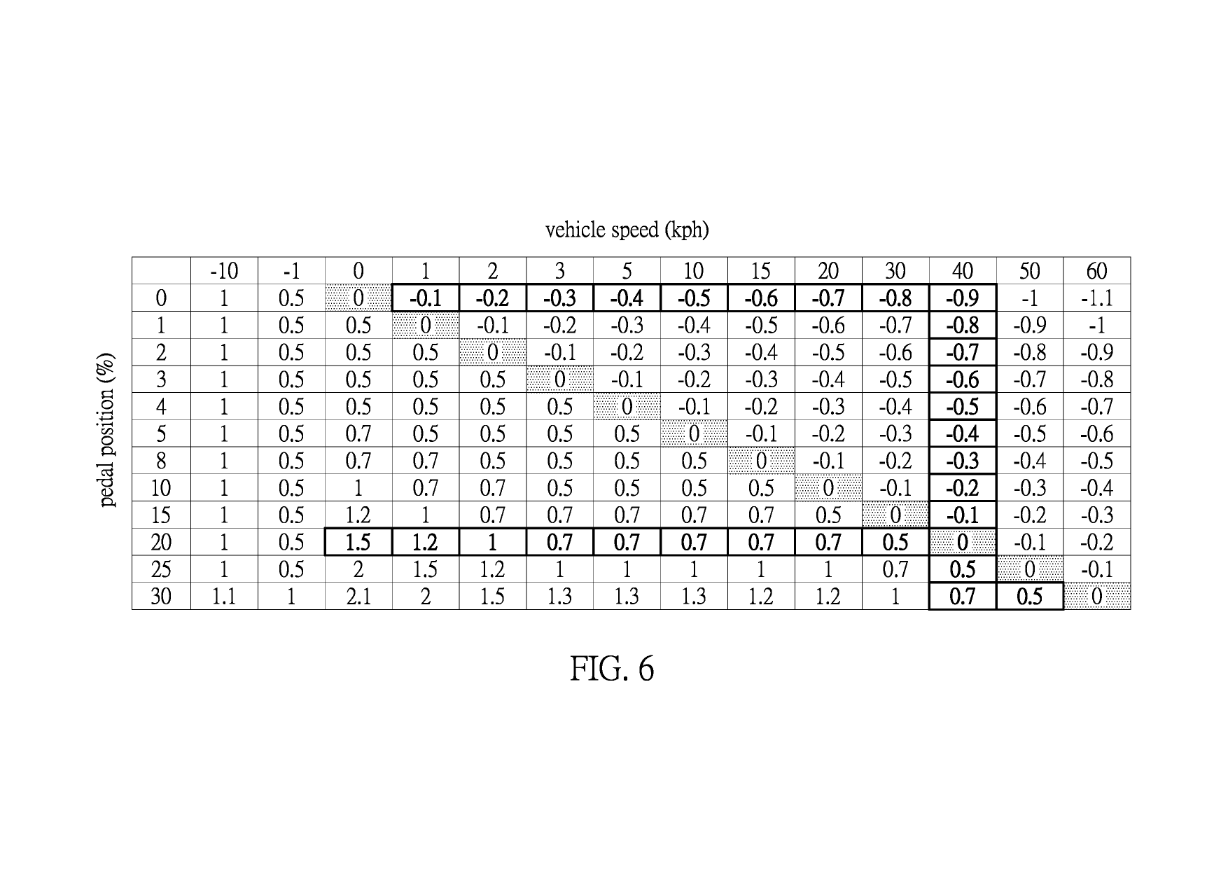

Referring to FIG. 6, the acceleration mapping table includes the vehicle speed of the electric vehicle, the pedal position of the accelerator pedal, and the target acceleration of the electric vehicle, and correspondence relationships between these information. The electric vehicle of the present disclosure has multiple driving modes, such as ECO mode, normal mode, and sport mode. Specifically, different driving modes have different acceleration mapping tables. The acceleration mapping table, along with the torque variation mapping table and the braking torque mapping table mentioned later, can all be stored in the storage unit 15 of the control module 1 (in FIG. 2).

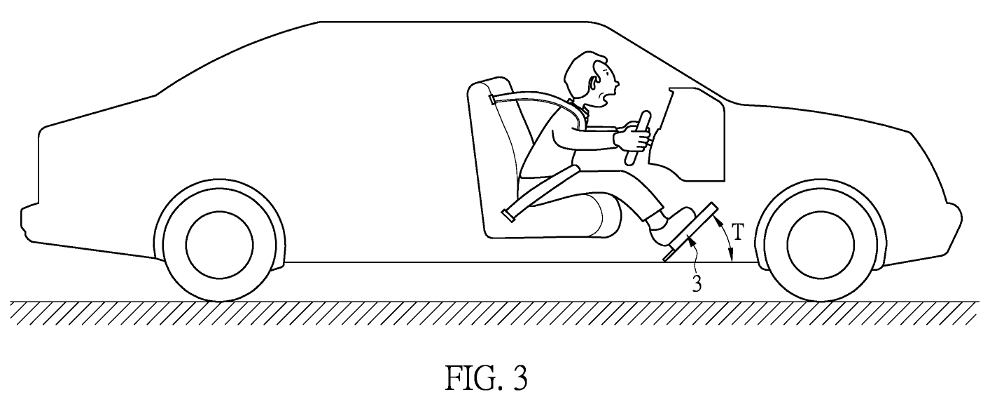

For example, when the driver operates the electric vehicle in normal mode, the control module 1 selects the acceleration mapping table corresponding to normal mode. The vertical axis numbers of the acceleration mapping table represent the pedal position T of the accelerator pedal 3 (as shown in FIG. 3), while the horizontal axis numbers represent the vehicle speed, using the unit in kph (kilometers per hour). Referring to FIG. 3, the pedal position T ranges from 0% to 100%, where 0% indicates that the accelerator pedal 3 is fully released and not pressed, and 100% indicates that the accelerator pedal 3 is fully depressed.

It should be noted that the acceleration mapping table in FIG. 6 does not show all the acceleration values (in units of km/h²), but only provides a portion of the acceleration values for illustrative purposes. Additionally, the acceleration values in the acceleration mapping table in FIG. 6 are disclosed for exemplary purposes only, and the present disclosure is not limited thereto.

For example, when the driver presses down the accelerator pedal 3 to the pedal position T of 20%, causing the electric vehicle to accelerate from a 0 kph to 40 kph, such that the vehicle has a forward target acceleration (i.e., a position acceleration value as shown in FIG. 6). During the acceleration process, the target acceleration can be determined by the control module 1 based on the acceleration mapping table. By looking up the table, the control module 1 selects the target acceleration corresponding to the current vehicle speed and the current pedal position. With the pedal position T being maintained at 20%, as the vehicle speed gradually increases from 0 kph to a target speed (e.g., 40 kph), the target acceleration gradually decreases. As shown in FIG. 6, the target acceleration gradually decreases from 1.5 km/h², 1.2 km/h², 1 km/h²... down to 0 km/h².

Reference is further made to FIG. 6. When the driver further increases the vehicle speed to 60 kph by pressing down on the accelerator pedal 3, the pedal position T increases to 30%, and the target acceleration increases from 0 km/h² to 0.7 km/h². Then, with the pedal position T maintained at 30%, as the vehicle speed gradually increases from 40 kph to another target speed (60 kph), the target acceleration gradually decreases from 0.7 km/h², 0.5 km/h²... down to 0 km/h².

On the other hand, when the driver reduces the vehicle speed, for example, from 40 kph to 0 kph, the driver can completely release the accelerator pedal 3, causing the pedal position T to decrease from 20% to 0 immediately, such that the electric vehicle has a reverse target acceleration (i.e., a negative acceleration value as shown in FIG. 6). The target acceleration increases from 0, -0.1 km/h², -0.2 km/h²... up to -0.9 km/h². Then, with the pedal position T maintained at 0%, as the vehicle speed gradually decreases from 40 kph to the target speed (0 kph, i.e., complete stop), the target acceleration decreases from -0.9 km/h², -0.8 km/h², -0.7 km/h²... down to 0 km/h².

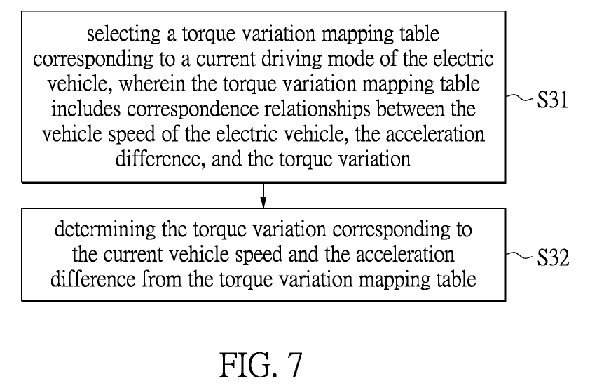

Reference is made to FIGS. 1, 4, and 7. After selecting the corresponding target acceleration from the acceleration mapping table, the control module 1 subtracts the longitudinal acceleration obtained from the acceleration sensor 6 from the target acceleration to calculate the acceleration difference (step S2). Then, the control module 1 determines the torque change amount based on the acceleration difference and the vehicle speed (step S3). In step S3, the control module 1 selects a torque variation mapping table corresponding to the current driving mode of the electric vehicle and determines the torque variation corresponding to the current vehicle speed (step S31) and the acceleration difference from the torque variation mapping table (step S32).

The torque variation mapping table includes the vehicle speed of the electric vehicle, the acceleration difference, and the torque variation, and correspondence relationships between the vehicle speed of the electric vehicle, the acceleration difference, and the torque variation. When the driver operates the electric vehicle in normal mode, the control module 1 selects the torque variation mapping table corresponding to normal mode. By looking up the table, the control module 1 selects the torque variation (referred to as a first torque variation) corresponding to the acceleration difference and the current vehicle speed.

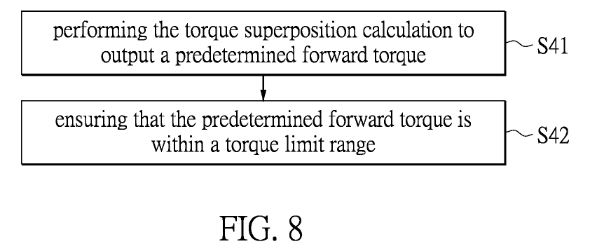

Referring to FIG. 8, the control module 1 performs the torque superposition calculation on the forward torque based on the torque variation, and control the motor assembly 2 to adjust the forward torque accordingly (step S4). In step S4, the control module 1 performs the torque superposition calculation to output a predetermined forward torque (step S41) and ensures that the predetermined forward torque is within a torque limit range (step S42).

Specifically, the control module 1 controls the motor assembly 2 to adjust the output forward torque based on the selected first torque variation, which means adding the first torque variation to the current forward torque to obtain a corrected predetermined forward torque (referred to as a first predetermined forward torque for convenience).

The electric vehicle increases the vehicle speed by outputting the first predetermined forward torque through the motor assembly 2. Then, the control module 1 continues to obtain the enhanced vehicle speed to determine another target acceleration through looking up the acceleration mapping table and calculating another acceleration difference accordingly. Then, similarly, another torque variation (referred to as a second torque variation) is obtained through the torque variation mapping table. The control module 1 adjusts the first predetermined forward torque previously output by the motor assembly 2 based on the second torque variation, adding the second torque variation to the first predetermined forward torque to obtain a further corrected forward torque. Through this process, the control module 1 can repeatedly perform the above steps to calculate torque superposition for the forward torque output by the motor assembly 2, thereby continuously adjusting the forward torque that the motor assembly 2 is intended to output.

Therefore, in the present disclosure, the torque control system for the electric vehicle utilizes the torque superposition calculation, so that when the driver presses the accelerator pedal 3, the torque control system determines the required acceleration for the vehicle based on the pedal position T and calculates the output torque. If the driver maintains the pedal position T at a fixed value while driving the electric vehicle, the vehicle accelerates to the set target vehicle speed and then moves at a constant vehicle speed, eliminating the need to control the accelerator pedal 3 to maintain the constant vehicle speed, as is required in existing vehicles (i.e., the fuel-powered vehicles or the electric vehicles). Furthermore, since the torque control system adjusts the output torque according to the current actual state of the vehicle, the driver’s comfort is not significantly affected by differences in vehicle load or changes in road gradient. Additionally, the driver’s perception of the vehicle’s driving state, such as when pressing the accelerator pedal to accelerate the vehicle, will not be significantly different, making the vehicle easier to control.

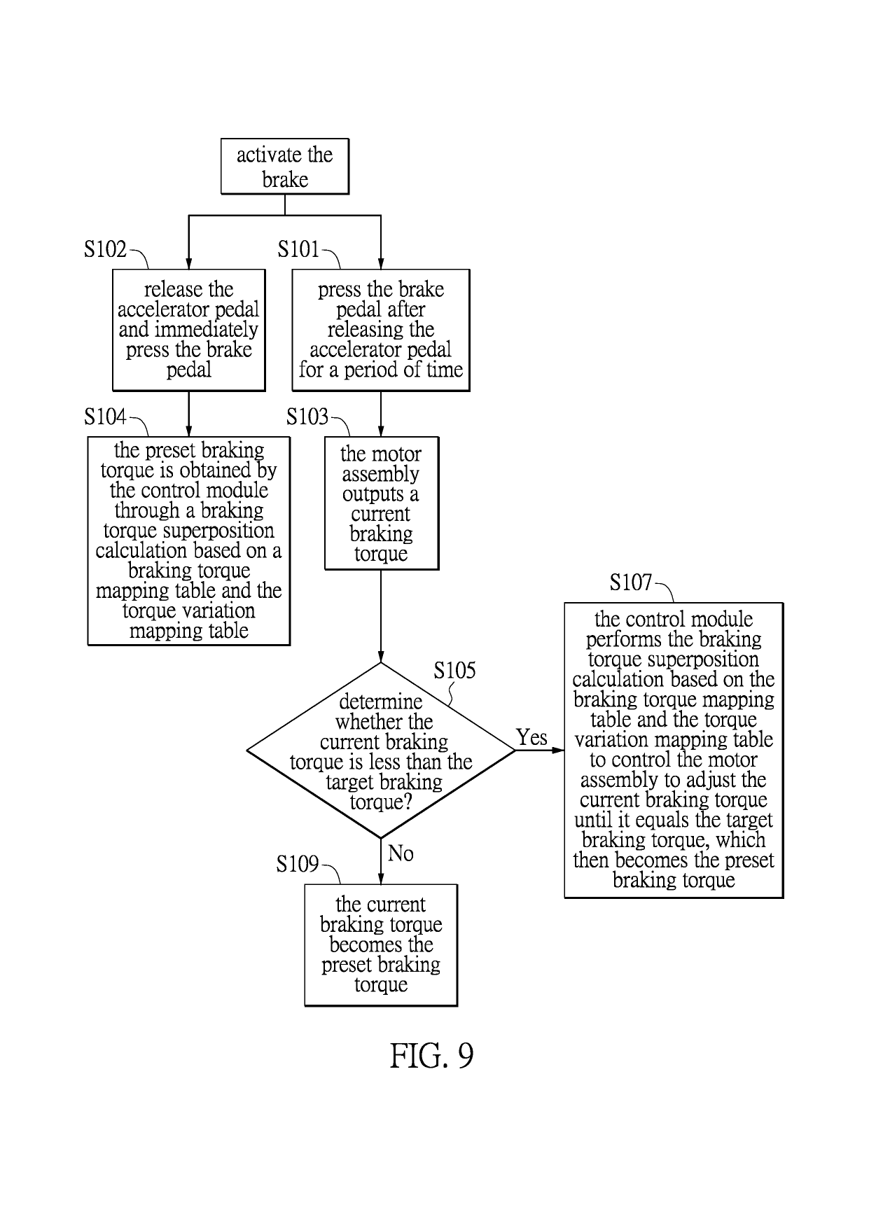

Before the motor assembly 2 outputs the predetermined forward torque, the control module 1 ensures that the predetermined forward torque is within a torque limit range. As shown in FIG. 9, the torque limit range refers to the condition where the predetermined forward torque is greater than a lower limit and less than an upper limit. The upper limit value equals a maximum forward torque that the motor assembly 2 can output, and the lower limit value equals an absolute value of a preset braking torque output by the motor assembly 2.

The lower limit value of the predetermined forward torque is a result calculated collectively by the vehicle controller 12, the motor controller 14, and battery management system (BMS) (not shown in the figures) within the control module 1 of the electric vehicle. Generally speaking, the lower limit of the predetermined forward torque output by the electric vehicle is greater than or at least equal to the preset braking torque output by the electric vehicle. Referring to FIG. 9, the preset braking torque is primarily generated during the deceleration of an electric vehicle. When the driver releases the accelerator pedal 3, or even further presses the brake pedal 4 to decelerate the electric vehicle (the control module 1 can detect the pedal position of the brake pedal 4 through a brake pedal position sensor 41), the control module 1 activates the regenerative braking function, such that the motor assembly 2 reverses its operating direction and outputs a preset braking torque to slow down the electric vehicle. During the deceleration process, the motor assembly 2 is used as a generator to convert the kinetic energy of the electric vehicle into electrical energy, which is stored in the vehicle’s battery (not shown in the figures), known as kinetic energy recovery.

The operation scenarios for the deceleration of the electric vehicle include a situation where the brake pedal 4 is pressed and another situation where the brake pedal 4 is not pressed. Each scenario will be explained below.

Reference is further made to FIGS. 1 and 2. For example, when the driver releases the accelerator pedal 3 but does not press the brake pedal 4, the preset braking torque is obtained by multiplying the maximum braking torque that the motor assembly 2 can output by a braking torque setting percentage. The braking torque setting percentage is set by a driver through an in-vehicle information system of the electric vehicle. The braking torque setting percentage is any value between 0 and 100%. The in-vehicle information system is integrated into the vehicle's display (not shown in the figures) and allows the driver to operate functions such as multimedia, navigation, music, and communication, as well as adjust the aforementioned braking torque setting percentage.

Existing electric vehicles also allow the driver to adjust the braking torque output by the motor. The existing electric vehicle provides several regenerative braking adjustment levels such as 20%, 50%, 70%,… etc. The driver can select different regenerative braking adjustment levels to adjust the braking torque value through the in-vehicle information system. However, these regenerative braking adjustment levels are fixed levels preset by the manufacturer, and the driver can only choose from these levels and cannot freely adjust to the desired braking torque. In other words, the driver can only select one of the regenerative braking adjustment levels to adjust the braking torque to a fixed proportion, while other regenerative braking adjustment levels outside of the options provided in the in-vehicle information system cannot be selected. In contrast, the torque control system provided by the present disclosure provides continuous braking torque settings without fixed levels, enabling the driver to adjust the required braking torque according to personal preference, enhancing the comfort during deceleration.

As shown in FIG. 9, the deceleration situation in the electric vehicle when the driver presses the brake pedal can be divided into the following two scenarios: the driver releases the accelerator pedal 3 and immediately presses the brake pedal 4; or the driver releases the accelerator pedal 3 for a period of time and then presses the brake pedal 4.

In steps S102 and S104 of FIG. 9, when the driver releases the accelerator pedal 3 and immediately presses the brake pedal 4 (step S102), the preset braking torque is obtained by the control module 1 through a braking torque superposition calculation based on a braking torque mapping table and the torque variation mapping table (step S104). The braking torque mapping table is used to represent the correspondence relationships between the braking torque setting percentage and the braking torque. Specifically, when the driver releases the accelerator pedal 3 and immediately presses the brake pedal 4, the motor assembly 2 immediately switches from outputting the forward torque to outputting the reverse torque, which is the braking torque. Subsequently, the control module 1 calculates the preset braking torque to be output based on the braking torque mapping table and the braking torque setting percentage set by the driver. Then, the control module 1 performs the braking torque superposition calculation by looking up the torque variation mapping table and accordingly controls the motor assembly 2 to continuously adjust the braking torque until the adjusted braking torque equals the preset braking torque value obtained from the braking torque mapping table before outputting it.

Specifically, when the driver presses the brake pedal 4 after releasing the accelerator pedal 3 for a period of time (step S101), since the accelerator pedal 3 has been released for some time, the motor assembly 2 has already output a current braking torque (step S103). Therefore, the control module 1 compares the current braking torque with a target braking torque obtained from the braking torque mapping table to determine whether the current braking torque is less than the target braking torque (step S105).

If the control module 1 determines that the current braking torque is not less than (i.e., greater than or equal to) the target braking torque, then the current braking torque becomes the preset braking torque (step S109). In other words, the current braking torque does not require adjustment, and the motor assembly 2 directly outputs it as the preset braking torque.

On the other hand, if the control module 1 determines that the current braking torque is less than the target braking torque, the control module 1 performs the braking torque superposition calculation based on the braking torque mapping table and the torque variation mapping table to control the motor assembly 2 to adjust the current braking torque until it equals the target braking torque, which then becomes the preset braking torque (step S107). Specifically, the control module 1 calculates the preset braking torque to be output based on the braking torque mapping table and the braking torque setting percentage set by the driver. Subsequently, the control module 1 further performs the braking torque superposition calculation through the torque variation mapping table and controls motor assembly 2 to continuously adjust the braking torque until the adjusted braking torque equals to the preset braking torque value obtained from the braking torque mapping table before outputting it.

### [Beneficial Effects of the Embodiment]

The torque control system for the electric vehicle provided by the present disclosure outputs acceleration-based control commands to control the output torque of the electric vehicle. The driver only needs to determine different target accelerations, and the torque control system can calculate an appropriate torque for the vehicle at that moment. As a result, the number of lookup tables stored in the system can be reduced, and the calibration time can be shortened. Furthermore, since the output torque of the electric vehicle is adjusted based on the vehicle’s overall acceleration, the effects of road surface variations, road inclines, and vehicle load during operation can be mitigated, eliminating the need for the driver to frequently press the accelerator pedal according to road conditions and thereby reducing the complexity of vehicle handling.

Furthermore, in the existing technology, the braking torque corresponding to the regenerative braking adjustment levels of the electric vehicle is preset by the manufacturer, and the driver can only choose from these levels and cannot freely adjust to the desired braking torque. In contrast, the torque control system provided by the present disclosure provides continuous braking torque settings without fixed levels, enabling the driver to adjust the required braking torque according to personal preference. In other words, the braking torque required for the regenerative braking in the present disclosure is calculated by the torque control system rather than relying on traditionally pre-designed calibration parameters.

Therefore, the braking torque required for regenerative braking can be appropriately adjusted based on calculation results, achieving stepless switching for kinetic energy recovery. For example, when the electric vehicle decelerates on a downhill road for kinetic energy recovery, the driver in the electric vehicle does not experience varying deceleration sensations due to differences in vehicle load or road slope. Therefore, the driver can have a more comfortable ride. Additionally, since the torque control system for the electric vehicle allows the driver freely adjust the braking torque for regenerative braking, the amount of recovered kinetic energy can be maximized while maintaining ride comfort, thereby improving the overall energy efficiency of the vehicle.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A torque control system for an electric vehicle, comprising:
an accelerator pedal;
a brake pedal;
a motor assembly electrically connected to the accelerator pedal and the brake pedal, wherein the motor assembly is used to output a forward torque; and
a control module electrically connected to the motor assembly, wherein the control module is configured to:
obtain a vehicle speed of the electric vehicle and a pedal position of the accelerator pedal, and determine a target acceleration of the electric vehicle accordingly;
calculate the target acceleration and a longitudinal acceleration of the electric vehicle to obtain an acceleration difference;
determine a torque variation based on the acceleration difference and the vehicle speed; and
perform a torque superposition calculation on the forward torque based on the torque variation, and control the motor assembly to adjust the forward torque accordingly.

2. The torque control system for the electric vehicle according to claim 1, wherein, in the process of obtaining the vehicle speed of the electric vehicle and the pedal position of the accelerator pedal, and determining the target acceleration of the electric vehicle accordingly, the control module is further configured to:
select an acceleration mapping table corresponding to a current driving mode of the electric vehicle, wherein the acceleration mapping table includes correspondence relationships between the vehicle speed of the electric vehicle, the pedal position of the accelerator pedal, and the target acceleration; and
determine the target acceleration based on the current vehicle speed and the current pedal position from the acceleration mapping table.

3. The torque control system for the electric vehicle according to claim 1, wherein, in the process of determining the torque variation based on the acceleration difference and the vehicle speed, the control module is further configured to:
select a torque variation mapping table corresponding to a current driving mode of the electric vehicle, wherein the torque variation mapping table includes correspondence relationships between the vehicle speed of the electric vehicle, the acceleration difference, and the torque variation; and
determine the torque variation corresponding to the current vehicle speed and the acceleration difference from the torque variation mapping table.

4. The torque control system for the electric vehicle according to claim 3, wherein, in the process of performing the torque superposition calculation on the forward torque based on the torque variation, and controlling the motor assembly to adjust the forward torque accordingly, the control module is further configured to:
perform the torque superposition calculation to output a predetermined forward torque; and
ensure that the predetermined forward torque is within a torque limit range.

5. The torque control system for the electric vehicle according to claim 4, wherein, when the predetermined forward torque is within the torque limit range, the predetermined forward torque is greater than a lower limit value and less than an upper limit value; wherein the upper limit value equals a maximum forward torque that the motor assembly is configured to output, and the lower limit value equals an absolute value of a preset braking torque output by the motor assembly.

6. The torque control system for the electric vehicle according to claim 5, when the accelerator pedal is released and the brake pedal is not pressed, the preset braking torque is obtained by multiplying a maximum braking torque that the motor assembly is configured to output by a braking torque setting percentage.

7. The torque control system for the electric vehicle according to claim 6, wherein the braking torque setting percentage is any value between 0 and 100%.

8. The torque control system for the electric vehicle according to claim 6, wherein the braking torque setting percentage is set by a driver through an in-vehicle information system.

9. The torque control system for the electric vehicle according to claim 5, wherein, when the accelerator pedal is released and the brake pedal is immediately pressed, the preset braking torque is obtained by the control module performing the torque superposition calculation based on a braking torque mapping table.

10. The torque control system for the electric vehicle according to claim 5, wherein, when the accelerator pedal has been released for a period of time and then the brake pedal is pressed, the motor assembly outputs a current braking torque, and wherein:
if the current braking torque is greater than or equal to the target braking torque obtained by the control module based on the braking torque mapping table, the current braking torque is the preset braking torque; or
if the current braking torque is less than the target braking torque obtained by the control module based on the braking torque mapping table, the control module performs a braking torque superposition calculation according to the braking torque setting percentage and the braking torque mapping table, to control the motor assembly to adjust the current braking torque to be equal to the target braking torque, such that the target braking torque is the preset braking torque.
